(19) United States
(12) Patent Application Publication
(10) Pub. No.: US 2006/0187838 A1
(43) Pub. Date: Aug. 24, 2006

(54) Method and system for load balancing in a network platform

(75) Inventors: Arun Alex, Bartlett, IL (US); Sudhir Kunnath, Bolingbrook, IL (US); Abhishek Sharma, Streamwood, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc., Alameda, CA (US)

(21) Appl. No.: 11/066,789

(22) Filed: Feb. 24, 2005

(51) Int. Cl. H04J 1/16; H04J 3/14; H04L 12/26

(52) U.S. Cl. 370/235; 370/252

(57) ABSTRACT

A method for load balancing communication session processing in a data network platform. The method includes maintaining a first table that associates a plurality of valid communication sessions being processed by the platform with respective application processing cards of a plurality of application processing cards included in a network platform. The method also includes maintaining a second table associating respective activity loads with the plurality of application processing cards. The activity loads are monitored, and if the activity load of a given application processing card exceeds a predetermined limit, the method includes identifying a valid communication session (or sessions) being processed by the given application processing card to be moved to another application processing card. The method then further includes moving the identified communication session to the other application processing card.

### CROSS REFERENCE TO RELATED APPLICATIONS

This application is related to commonly assigned, co-pending U.S. patent applications Ser. No. 11/003,546, filed on Dec. 3, 2004 and entitled “Method and System for Decryption of Encrypted Packets” and Ser. No. 11/003,841, also filed on Dec. 3, 2004 and entitled “Method and System for Providing Packet Data Services”, both to the same inventors as the instant application. The disclosures of U.S. patent application Ser. Nos. 11/003,546 and 11/003,841 are incorporated herein by reference in their entirety.

### BACKGROUND

I. Field

This invention is related to data communications and, more specifically, to systems and methods for load balancing communication session processing in a data network platform.

II. Description of Related Art

The use of technology for accessing the Internet, the World Wide Web and/or other types of packet data networks (e.g., business or private networks) continues to increase at a rapid rate. The advent of wireless mobile devices, such as wireless phones, wireless personal digital assistants (PDAs) and wireless network enabled notebook computers, provides users of such devices with the ability to access data networks from any location where radio coverage facilitating such access is available. Such access may be provided using protocols such as the Mobile Internet Protocol (Mobile IP). Mobile IP functions may be implemented in accordance with the Code Division Multiple Access (CDMA) 2000 standard, which is described in further detail in the Telecommunications Industry Association (“TIA”) standards IS-95A and IS-95B, which are both incorporated herein by reference in their entirety. CDMA is also described in the International Telecommunications Union (“ITU”) IMT-2000 series of standards, which are all incorporated herein by reference in their entirety. CDMA is further described in the TIA IS-2000 series of standards, which are all incorporated herein by reference in their entirety. The IS-2000 series of standards are commonly referred to as CDMA2000.

The rapid growth in the use of such techniques for accessing data networks has motivated the development of network systems that provide such data services with ever-increasing bandwidth. Additionally, rising infrastructure and operating costs associated with implementing and maintaining such networks (e.g., Mobile IP networks) has motivated the development of network devices and systems/platforms that may be employed in multiple applications and/or provide multiple functions concurrently. For example, the same network platform may provide both packet data serving node (PDSN) functions and/or home agent (HA) functions in a Mobile IP network. PDSN and HA services are described in detail in the CDMA2000 standards and will not be described in detail here. In mobile IP networks, it is common to use multiple devices and/or platforms for providing such services with the processing of communication sessions (calls) being distributed among the multiple devices and/or platforms. Additionally, with the development of higher bandwidth systems and increases in data network capabilities, there has been an associated increase in the quality of service expectations of users of these networks.

In order to provide users of such data network (e.g., mobile IP networks) with an acceptable quality of service, service providers of such data services use a number of techniques to increase the efficiency of the network devices and platforms providing such services so as to more effectively use the available bandwidth in providing their customers access to, for example, the Word Wide Web, the Internet and/or private networks. One such technique is referred to as load balancing. Load balancing is used to distribute the processing of communication sessions across multiple network devices or platforms (collectively “devices” or “platforms”). The aim of load balancing is to distribute the communication session (call) processing load, e.g., PDSN and/or HA processing, as evenly as possible across the available network devices providing such data services. For example, in a mobile IP network where four PDSN platforms are used, load balancing may be used to attempt to have each PDSN platform handle, on average, twenty-five percent of the PDSN data traffic in the network.

Current approaches for balancing a call processing load across multiple network platforms are implemented as part of the call setup process. In a mobile IP network, calls are setup in accordance with CDMA2000 standards and load balancing is currently performed in conjunction with this call set up process. For example, in a mobile IP network that includes more than one network platform for providing a particular service, e.g., PDSN services, the particular platform of the multiple platforms that will be responsible for processing data traffic associated with a given call is assigned at the time the call is set up. Such an approach has certain drawbacks, however.

As an example, in one embodiment using such a load balancing technique, new calls are received by a control node. As part of the call setup up, the control node will determine a network platform to assign the call to for processing (e.g., to provide PDSN services for the call). This determination is made based on the loading of the available network platforms providing such services at the time of call setup. The loading of the platforms may be determined in any number of fashions. For example, the respective loadings may be determined based on the average amount of data traffic through each entity over a given period of time. Accordingly, in this approach, the new call is assigned to (and then processed by) the network platform with the lowest average traffic in that given period of time.

However, after the new call is assigned, it is possible that the platform that had the lowest average traffic during the given period of time (e.g., the platform to which the new call is assigned) may be responsible for processing a number of communication sessions that were dormant (e.g., valid but not actively communicating data) during the given period of time. If a large portion (or all) of these dormant session were to become active (e.g., to begin actively communicating data) after the new call is assigned to that platform, it is possible that the network platform to which the new call has been assigned could become the most heavily loaded of the available network platforms. Such a situation is undesirable as the user experiences for calls being processed by this platform (including the new call that was assigned) would be adversely impacted due to the reduction in available bandwidth resulting from the increase in active data communication for the previously dormant calls (communication sessions). Therefore, alternative approaches for load balancing call processing (e.g., providing mobile IP services) that more efficiently use the bandwidth of network devices and platforms processing calls are desirable.

### SUMMARY

Methods and systems for balancing the processing load for data communication sessions in a data network are disclosed. The methods and systems provide for dynamically balancing communication session processing loads, such as, for example, balancing, across multiple network platforms, the provision of packet data serving node (PDSN) and/or home agent (HA) services in a mobile Internet Protocol (mobile IP) data network. Communication session processing may also be termed call processing, with each communication session corresponding to a “call” from a separate mobile station (e.g., a mobile phone with Internet capability). The terms “communication session” and “call” are used interchangeably throughout this disclosure.

A method for performing such load balancing includes maintaining a first table that associates a plurality of valid communication sessions being processed in a network platform with respective application processing cards of a plurality of application processing cards included in the network platform. Such a table could be maintained by a control entity in the network platform, where the platform is providing, for example, PDSN services or HA services. In such an implementation, the table could be periodically communicated from the control entity to the plurality of application processing cards (or devices), where the application processing cards are operationally coupled with the control entity.

In such a configuration, the application processing cards perform the call processing (e.g., execute service logic to provide PDSN and/or HA services) while the control entity distributes data for processing to the application processing cards. In one such embodiment, a packet switch card included in a network platform may be coupled with a plurality of application processing cards also included in the platform. The packet switch card receives data communication traffic and routes it to the application processing cards for call processing based, in part, on the first table.

The method further includes maintaining a second table that associates respective activity loads with the plurality of application processing cards. This table may also be maintained in, for example, a packet switch card and periodically distributed to the application processing cards of the network platform for use in load balancing. The activity loads may be indicated in the table by a value within a predetermined range of numbers, such as a range of ‘1’ to ‘100’, for example. In maintaining the table, the application processing cards periodically send an updated value to the packet switch card indicating their current activity load. The packet switch card then updates the table based on these periodic updates and communicates the table to each of the application processing cards.

The activity load of each application processing card is monitored. This may include monitoring processor utilization and/or memory utilization on the application processing card.

Alternatively, the amount of data being sent to each application processing card may be monitored by the packet switch card as a measure of the activity load of the card. The measure of data flow may be used independently or in combination with other parameters (such as processor and/or memory utilization) to determine an activity load for each packet processing card.

When the activity load monitoring determines that the activity load of a given application processing card exceeds a predetermined limit, such as being over a certain activity load for a certain period of time, the given application card then identifies (e.g., using service logic included in the application processing card) one or more communication sessions (calls) to be moved to one or more other application cards. This determination can be made in any number of fashions. For example, statistics for each call that are included in a call context table in the application processing card may be examined along with the first and second tables received from the packet switch card, with the objective being to balance the call processing load as evenly as possible across the application processing cards. Alternatively, the packet switch card, either independently or in combination with the given application processing card, could determine which calls are to be moved.

Once the call(s) that is (are)are going to be moved is (are) identified for the given application processing card, a call context (or call contexts) for the identified call(s) is (are) moved to the other application card or cards, as the case may be. The call context(s) may be moved using software agents on both the sending and receiving application processing cards. For example, a software agent on the sending application processing card may collect the call context information for each call being moved and the software agent on the receiving card(s) may use the received information to set up the call on the receiving card(s).

Once a moved call is set up on its new card, the first table is updated to indicate that the call has been moved to the receiving card, the call context is added to the call context table in the new card and the call context is deleted from the call context table in the original card. The second table is then updated with new respective activity loads, and the activity load of the application cards continues to be monitored to determine if moving any other calls is appropriate (e.g., is the predetermined activity load threshold limit exceeded for any of the cards).

A network platform that provides for load balancing includes a plurality of application processing cards, a packet switch card operationally coupled with the plurality of application processing cards and a backplane for communicating data between the packet switch and the plurality of application processing cards. The packet switch card and the plurality of application processing cards include machine executable instructions that, when executed, collectively provide for implementing load balancing methods, such as the method described above.

Such systems and methods overcome the drawbacks of current approaches because they provide for load balancing communication session (call) processing after calls have been setup, not just when the calls are originated. Such an approach provides for balancing call processing loads when the activity load of an application processing card significantly changes due to, for example, a number of dormant calls being serviced by the application processing card becoming active at substantially the same time.

These and other aspects will become apparent to those of ordinary skill in the art by reading the following detailed description, with reference, where appropriate, to the accompanying drawings. Further, it is to be understood that the embodiments noted in this summary are only examples and not intended to limit the scope of the invention as claimed.

### BRIEF DESCRIPTION OF THE DRAWINGS

Exemplary embodiments of the present invention are described herein with reference to the drawings, in which:

FIG. 1 is a diagram of a communication network that may employ the systems and methods illustrated in FIGS. 2-8;

FIGS. 2A and 2B are two diagrams illustrating a backplane-based network platform for providing packet data serving node and/or home agent services in a Mobile IP network;

FIG. 3 is a block diagram of a packet-processing card (e.g., wireless application card) of the platform shown in FIGS. 2A and 2B;

FIG. 4 is a block diagram of a packet switch card of the platform shown in FIGS. 2A and 2B;

FIG. 5 is a table that associates calls with respective application processing cards responsible for processing those calls in the network platform of FIGS. 2A and 2B;

FIG. 6 is a table that includes a list of the application processing cards of the network platform illustrated in FIGS. 2A and 2B and the respective activity loads corresponding with those application processing cards;

FIG. 7 is a table that illustrates call contexts for a plurality of communication sessions (calls) being processed by a particular application processing card in the network platform of FIGS. 2A and 2B; and

FIG. 8 is a flowchart illustrating a method for load balancing communication session (call) processing that may be implemented by the platform of FIGS. 2A and 2B.

### DETAILED DESCRIPTION

Embodiments of network platforms and methods for load balancing communication session processing are discussed generally in the context of wireless communication systems and packet data networks. However, it will be appreciated that the invention is not limited in this respect and that embodiments of the invention may be implemented in any number of types of communication systems, such as wired local area networks, and wired wide area networks, among any other type of appropriate data and/or communication networks. As in most telecommunication and data applications, it will also be appreciated that many of the elements of the various embodiments described herein are functional entities that may be implemented as hardware, firmware and/or software or using any other appropriate technique. Additionally, many of the elements described in this disclosure may be implemented as discrete components or in conjunction with other components, in any suitable combination and location.

Organization of the Disclosure

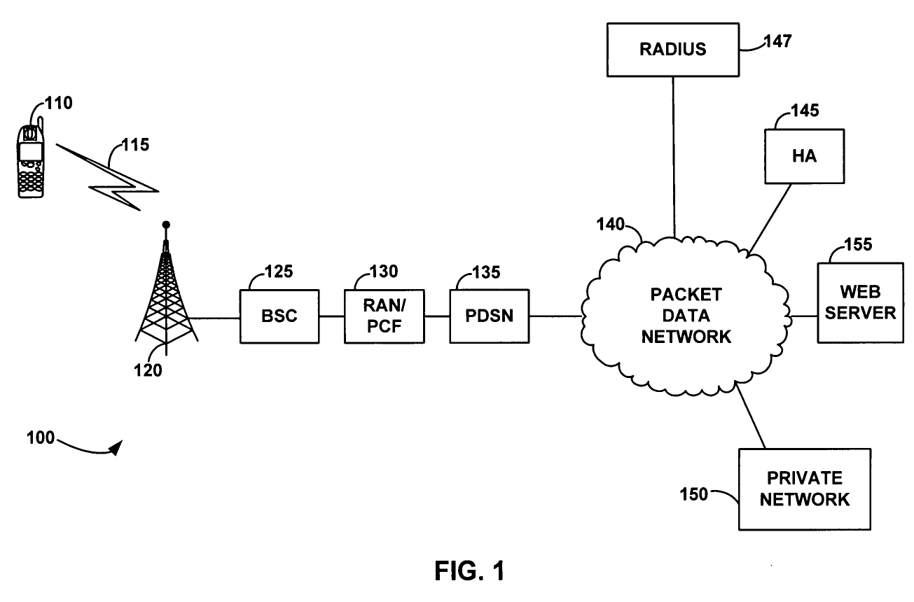

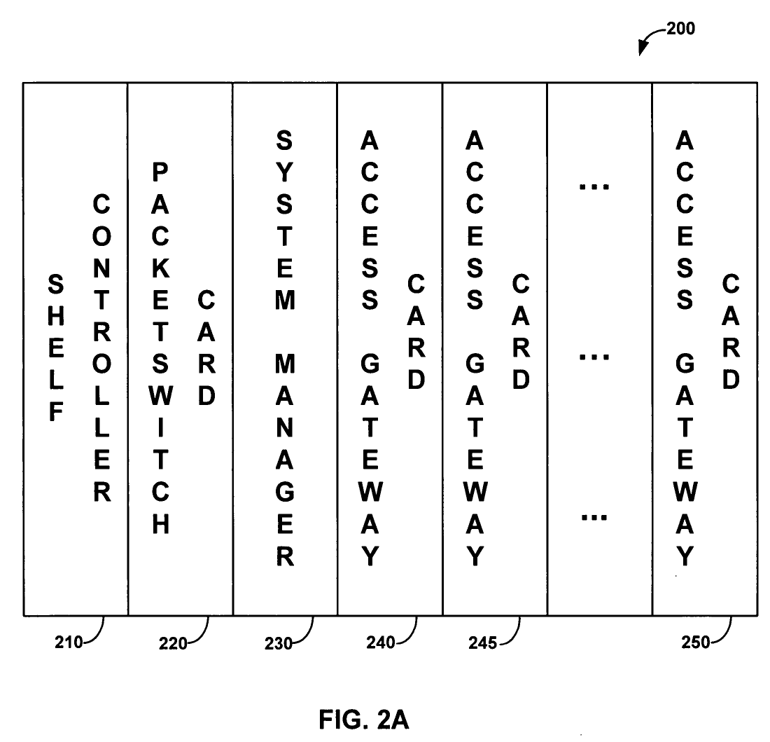

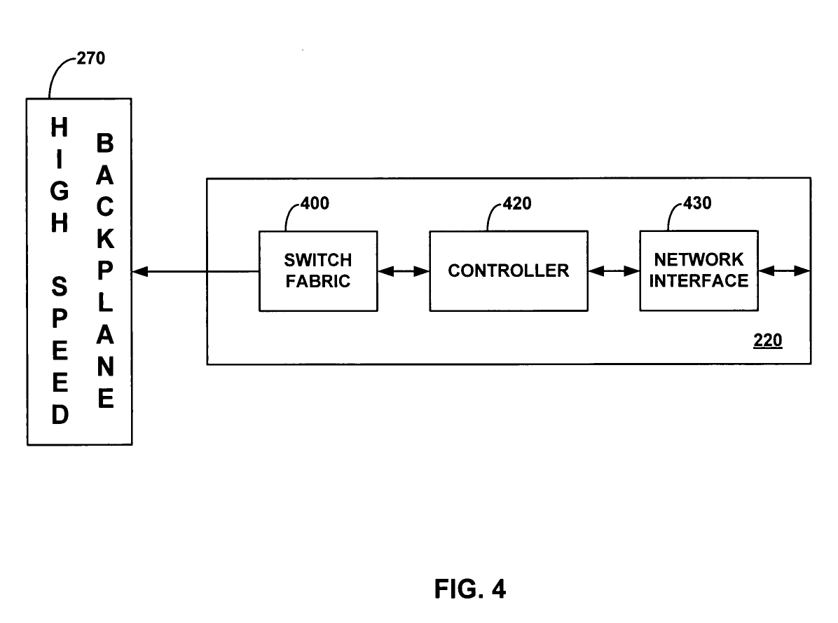

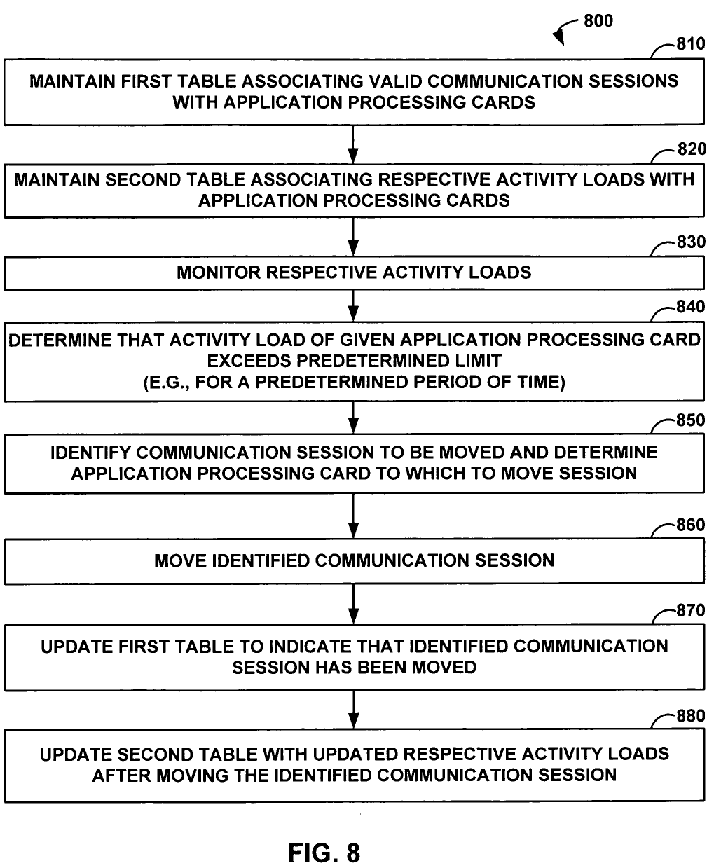

This disclosure is organized as follows. First, a data network in which systems and methods for dynamically load balancing the processing of communication sessions (calls) may be employed is described with reference to FIG. 1. The network of FIG. 1 includes a wireless data network that implements the Mobile IP protocol in accordance with the CDMA2000 standard. Second, a network platform in which the load balancing methods described herein may be implemented is described with reference to FIGS. 2-4. The network platform may be used in the system of FIG. 1 to provide, for example, packet data serving node and/or home agent services in the data network. Third, various tables used to implement a load balancing method and for providing network services with the platform of FIGS. 2A and 2B are described with reference to FIGS. 5-7. Fourth, an embodiment of a call processing load balancing method is described with reference to FIG. 8.

Data Communications Network

FIG. 1 shows a data communication network 100 that is used for packet data communication. In network 100, a mobile station 110 is a wireless device, such as a wireless phone, a wireless personal digital assistant (PDA), a wireless enabled computer, or any other appropriate device that may be used in conjunction with a wireless communication network for data communications.

The mobile station 110 communicates with a radio network over an air interface 115. The radio network includes a base transceiver station (BTS) 120 that directly communicates with the client station 110 over the air interface 115 using radio frequency signals. The mobile station 110 may communicate with the BTS 120 using a variety of different protocols. For example, such communication may be accomplished using the CDMA2000 standard. Other wireless protocols may also be used. For example, the mobile station 110 and the BTS 120 may communicate using Wideband CDMA (WCDMA), Time Division-Synchronous CDMA (TD-SCDMA), Advanced Mobile Phone Service (AMPS), Digital AMPS (D-AMPS), Universal Mobile Telecommunications System (UMTS), Global System for Mobile Communication (GSM), IS-136, Time Division Multiple Access (TDMA), IEEE 802.11, Bluetooth (e.g., 802.15.1), MMDS, DECT, integrated digital enhanced network (IDEN), general packet radio service (GPRS) or other protocols.

The BTS 120 is coupled with a base station controller (BSC) 125. The BSC 125 is further coupled with a Radio Access Network/Packet Control Function Device 130, which in turn is coupled with a packet-data-serving node (PDSN) 135. The PDSN 135 then connects to a packet data network 140, such as the public Internet. These components and their operation are all described in further detail in the CDMA standards and will not be described in detail here for the purpose of brevity and clarity.

Using this connectivity, the mobile station 110 is then able to communicate with devices on the packet data network 140, as well as devices coupled with the packet network 140, such as a home agent 145, a Web server 155 and a private network 150, as some examples. The Web server 155 provides the mobile station 110 access to the World Wide Web.

The data network of FIG. 1 also includes a Remote Authentication Dial-In User Service (RADIUS) sever 147 that is coupled with the HA 145. As is known, the RADIUS server 147 authenticates users, authorizes access to private networks and collects information for the purposes of accounting and billing (such as user access time and charges). RADIUS servers and their role in data networks implementing the Mobile IP and CDMA standards are described in more detail in the TIA IS-835-C standard.

Data communications in the data network 100 may be accomplished using communication tunnels. A communication tunnel is established in response to a call setup request. The communication tunnel may be established in accordance with the IS-835-C standard. Of course, other communication protocols are possible for establishing a communication tunnel. Briefly, for systems using the IS-835-C standard, a communication tunnel is setup by a mobile sending a registration request (e.g., and A11 request to a PDSN). This request is processed by the PDSN and/or HA and if accepted, a generic routing encapsulation (GRE) tunnel is setup for the call. An A11 registration reply is then sent to the mobile from the PDSN. The PDSN then negotiates point-to-point protocol (PPP) parameters with the mobile via the GRE tunnel prior to setting up the complete call context.

Network services are provided by the various platforms of the network 100, such as the PDSN 135, the HA 145 and the Web Server 155, for example. However, for purposes of this disclosure, network platforms and methods for providing network services will be discussed generally in the context of the PDSN 135 and the HA 145. Of course, other types of network services, such as VPN services, may be provided in similar fashion as the embodiments disclosed here.

Backplane-Based Network Platform

FIGS. 2-4 illustrate a backplane-based network platform 200 that is used to provide PDSN and/or HA services in a Mobile IP compliant data communication networks, such as the network 100 shown in FIG. 1. The platform 200 may be used to implement the PDSN 135 of FIG. 1 and/or the HA 145 of FIG. 1. Due to its backplane-based design, the platform 200 is able to provide both PDSN and HA services simultaneously. In such an application, PDSN services are provided using a first IP address while HA services are provided using a second IP address.

1. Overview

Backplane-based systems/platforms typically include a high-speed backplane for communicating packet data from one packet-processing card to another in the same platform. One such network device is the Total Control 2000 (TC2K) available from UTStarcom, Inc., 1275 Harbor Bay Parkway, Alameda, Calif. 94502. The backplane-based design allows for all packet data traffic in the TC2K system to be aggregated onto a single IP address.

Specifically, the TC2K backplane-based system includes multiple wireless application processing cards (packet-processing cards) coupled, via a high speed-backplane, with a packet switch card. The packet switch card performs packet routing and forwarding functions in the TC2K system. Because the packet switch card is capable of routing packets to the individual wireless applications cards, the TC2K system is able to aggregate all of the data traffic for the system onto a single network address (e.g., an IP address in this example) or a reduced number of IP addresses, depending on the particular implementation. Therefore, all of the application cards in the TC2K system may operate using the same IP address, or a number of IP addresses that is less that the total number of wireless application cards in the system. The packet switch routes packets to individual wireless application cards for processing based on the content of each packet.

For example, the packets may be routed based on a communication session identifier (e.g., the source IP address of the packet) that is included in the header of each packet. After determining the communication session identifier from the packet, the packet switch determines the wireless application card responsible for processing packets associated with that specific communication session. The packet switch comparing the communication system identifier from the packet to a table associating communication session identifiers and wireless application cards (e.g., such as the table shown in FIG. 5) can make this determination, for example.

Furthermore, improvements in data networking hardware (e.g., routers, servers, etc.) have lead to corresponding increases in the data bandwidth that is available over a single network connection. Network speeds of 1 gigabit per second on a single cable (1 gigabit=1×10⁹ bits) are currently readily available, with network speeds of 10 gigabits per second also becoming more readily available. Such increases in the data bandwidth available on a single network connection allow systems (such as the TC2K) implementing a single-IP address (or fewer IP addresses than the total number of application cards in the system) to employ a single network cable per IP address that have even greater data bandwidth than previous mid-plane systems. However, it may be desirable to employ two network cables per IP address for hardware redundancy and increased system reliability. For example, if an application card that is operating as a NIC for the provision of PDSN services were to fail, the second application card connected with the redundant network cable could be activated in its place, thus preventing a loss of network services.

A backplane based system (e.g., the TC2K system) may implement multiple network services in the same platform (e.g., PDSN and HA functions), where each function is provided using a single network address for each function. Such an approach allows for multiple (e.g., redundant) devices, such as packet-processing cards capable of implementing PDSN and HA functions, to be associated with each network address. In such an implementation, should one device fail, another (redundant) device can nearly seamlessly take its place and continue to provide network services without any perceptible service interruption from the user's perspective.

Backplane based network platforms implementing a single-IP address approach represent an improvement over prior approaches, such as approaches that used multiple network devices (e.g., PDSN or HA devices) each with a unique IP addresses and an individual network connection. Specifically, for example, the single-IP approach allows for a reduction in the number of network connections/cables and for the use of hardware redundancy, which results in a reduced number of possible failure points and a corresponding improvement in network reliability. In such backplane based systems, load-balancing may be said to be performed intra-system across the application processing cards operating as a single-IP address, rather than intersystem across multiple platforms or network devices operating with individual (multiple) IP addresses.

2. Architecture

FIGS. 2A and 2B illustrate two different representations of a backplane-based network platform/system 200. FIG. 2A illustrates an exemplary chassis arrangement for a backplane-based network platform 200 for providing PDSN and/or HA services. The platform 200 is substantially similar to the UTStarcom TC2K wireless network platform. For purposes of this discussion, systems and methods for load balancing will be generally discussed in the context of the TC2K system (e.g., the architecture illustrated in FIGS. 2A and 2B). Of course, other system architectures are possible.

The platform 200 includes a shelf controller card 210. While the platform 200 is illustrated with a single shelf controller 210, it will be appreciated that additional shelf controller cards may be implemented in the platform 200. For example, the UTStarcom TC2K platform includes two shelf controllers. The shelf controller provides hardware management for the platform 200 and provides low-speed Ethernet connectivity (e.g., 100 Mbps) between the components of the platform 200. For example, the shelf controller recognizes when a card (e.g., packet switch or packet-processing) is inserted or removed from the platform 200 and, accordingly, applies or removes power from the respective card slots. This functionality allows for the packet-processing and packet switch cards to be “hot-swapped” (e.g., removed and replaced while the system is in operation).

The platform 200 also includes a system manager card 230. As with the shelf controller card 210, the platform 200 is illustrated with a single system manager card 230. However, additional system manager cards may be included in the platform 200, such as for redundancy purposes. The system manager card 230 is coupled with a system management bus (not shown in FIG. 2A) and provides for configuring the components of the platform 200. For example, the system manager 230 is used to establish the type of service or services the platform 200 is to provide. Using the system manager 230, the platform 200 is configured to provide HA services, PDSN services or both. In the UTStarcom TC2K platform, system management is accomplished over a 100 mbps data bus (the system management bus) using the Simple Network Management Protocol (which is described in detail in the IETF's RFC 1157), as well as UTStarcom defined proprietary communication mechanisms. RFC 1157 is incorporated by reference herein in its entirety.

The platform 200 also includes a packet switch card 220. As with the shelf controller 210 and the system manager 230, the platform 200 is shown with a single packet switch card 200 for purposes of illustration. It will be appreciated that additional, redundant packet switch cards may be included in the platform 200. The TC2K system typically includes two packet switch cards.

The packet switch card 220 operates as a distribution point for data packets in the platform 200. Packets that are received by the packet switch card 220 are then routed or forwarded to a destination (e.g., for processing or egress from the platform 200). For packets being processed in the platform 200, the packet switch card 220 will examine each packet and communicate the individual packets to a respective access gateway (AGW) card of a plurality of AGW cards 240, 245 and 250 (packet-processing devices/cards or wireless application processing cards) based on this examination. As indicated by the dotted lines in FIG. 2A, the platform 200 may contain additional AGW cards. The AGW card to which a particular packet is routed depends on the type of packet and/or information contained in the packet headers, such as information contained in one or more of the Layer 2 to Layer 7 headers of Internet Protocol packets.

FIG. 2B illustrates the platform 200 in a block diagram. In FIG. 2B, the platform 200 further includes a high-speed backplane 270 and a system management bus 280 (alternatively system control bus). As is shown in FIG. 2B, the packet switch card 220 and the AGW cards 240, 245 and 250 are coupled with the backplane 270. The combination of the packet switch card 220 and the high-speed backplane 270 are referred to as a Media Data Bus (MDB) in the TC2K platform. The MDB is capable of handling gigabit Ethernet communication between the packet switch card 220 and the AGW cards 240-250. Packets being processed by the platform 200 are communicated via the MDB.

In FIG. 2B, the shelf controller card 210 and the system manager card 230 are coupled with the system management bus 280 (which may also be termed a system control bus), while the management bus 280 is in turn coupled with each of the AGW cards 240-250. As was discussed above, shelf controller card 210 implements hardware management functions for the platform 200 and provides low-speed Ethernet connectivity (e.g., 100 Mbps) between the components of the platform 200. As also discussed above, the system manager 230, via the management bus 280, configures the platform 200 in accordance with the services the platform is to provide.

3. Access Gateway Card (Packet-Processing Card)

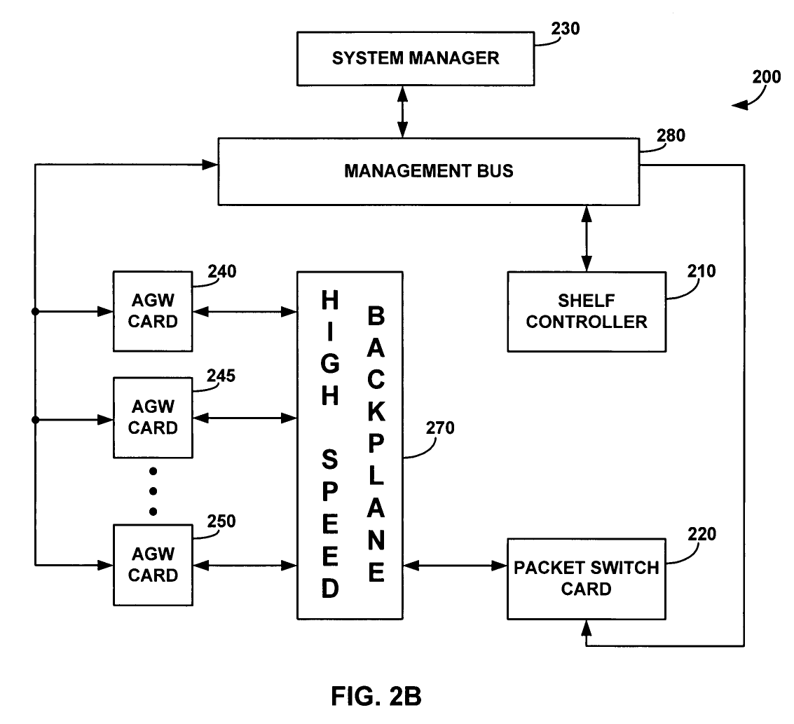

FIG. 3 illustrates the AGW Card 240 of the platform 200 in further detail. As shown in FIG. 3, the AGW card 240 is coupled with the high-speed backplane 270 and the management bus 280, as has been previously discussed. The AGW card 240 includes a Layer 2 (L2) Ethernet switch 300 that is coupled with the high-speed backplane 270. The L2 switch 300 receives packet data communicated to the AGW card 240 from the packet switch card 220 (via the backplane 270). Additionally, the L2 switch 300 communicates packet data that is being sent from the AGW card 240 to the packet switch card 220 onto the high-speed backplane 270. This communication is accomplished in accordance with any number of various data communication protocols, such as the Ethernet standard, for example. When the AGW card 240 is configured to communicate data between the network and the packet switch card, it may be said to be functioning as a NIC.

As was discussed above, processing of data packets in the platform 200 is accomplished in a distributed fashion. For example, the packet-switch 220 sends data packets to the AGW cards of the platform 200 that are dedicated to providing certain network services. For example, the packet switch 220 sends packets for PDSN processing to the AGW cards in the platform 200 that are designated to perform PDSN processing.

The packet switch 220 determines the AGW card of the platform 200 that is responsible for processing each packet. For example, the packet switch 220 may examine the headers of a data packet and determine that the packet is part of a communication session (e.g., based on the source IP address of the packet) for which the platform 200 is providing PDSN services. Based on the communication session identifier (e.g., the source IP address), the packet switch card forwards the packet to the AGW card that is responsible for providing PDSN services for that particular communication session. As an example, the packet switch card 220 may modify the Ethernet header of the packet (e.g., by inserting an MPLS header) to indicate that the AGW card 240 is the intended destination of the packet and then forward the packet to the appropriate AGW card.

Once a packet is received at the AGW card 240, the L2 switch 300 examines the Ethernet header of the packet and determines that the AGW card 240 is the destination. The L2 switch 300 of the AGW card 240 then sends the data packet to the controller 310, which processes the packet (e.g., performing Point-to-Point Protocol processing, as described in the IETF's RFCs 1661, 1662 or Generic Route Encapsulation Protocol processing, such as described in the IETF's RFC 2784) to produce a processed packet. The controller 310 then sends the processed packet to the L2 switch 300 to be communicated to the packet switch 220 via the backplane 270. AGW cards that are used for providing network services (e.g., PDSN services, HA services, decryption and/or encryption) are said to be operating as NACs. The processing of encrypted data packets is described in more detail in related U.S. application Ser. No. 11/003,546.

The AGW card 240 further includes an Ethernet port 330. The Ethernet port 330 may be coupled with an external network cable to allow the AGW card 240 to provide for data ingress and egress from the platform 200. In this situation, the AGW card 240 would function as a line card (NIC) and may not provide any decryption or packet processing services in the platform 200. In this situation, the L2 switch 300 effectively shunts the Ethernet port 330 with the high-speed backplane 270. As was noted above, all of the AGW cards (packet-processing cards) in the platform 200 may operate using a single-IP (network) address, with each AGW card being responsible for processing data packets associated with a specific, respective communication session or sessions.

The AGW card 240 additionally includes a packet buffer 340 that is coupled with the controller 310. The packet buffer 340 is used to buffer data packets at the AGW card 240 in the event those packets arrive at the AGW card 240 out of order. Data packets may arrive out of order for any number of reasons, such as a result of network congestion or distributed processing within the platform 200 (e.g., decryption processing as described in U.S. application Ser. No. 11/003,546). In the event such out of order arrival occurs, the buffer 340 holds the packets until a contiguous sequence of packets is present. The controller 310 then reorders the packets and processes them in sequence.

It will be appreciated that the AGW cards (e.g., the AGW card 240) of the platform 200 may operate in a number of fashions. Specifically, the AGW cards may operate as a NIC only, operate as a NAC only, or may operate as both a NIC and a NAC in the same system. Specifically, a data packet may be received from a data network by the AGW card 240. That packet is then sent to the packet switch card 220. The packet switch card 220 may then send the packet back to the AGW card 240 for PDSN or HA processing. The AGW card 240 then sends the processed packet back to the packet switch 220. The packet switch 220 may then send the packet back to the AGW card 240 for egress from the platform 200 (e.g. for communication to a destination via the network). In this situation, the AGW card 240 is operating as both a NIC and a NAC in providing network services.

4. Packet Switch Card

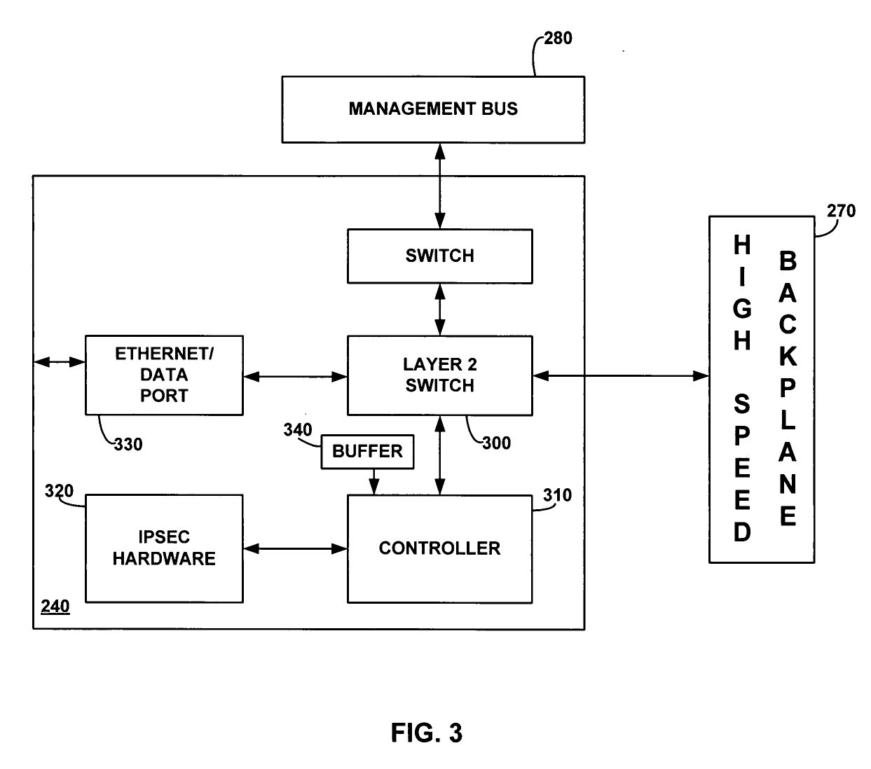

FIG. 4 illustrates the packet switch card 220 of the platform 200 in further detail. As is shown in FIG. 4, the packet switch card 220 is coupled with the high-speed backplane 270 via a switch fabric 400. As has been previously described, the packet switch card 220 communicates packet data with (to and from) the AGW cards of the platform 200 via the MDB (which includes the packet switch card 220 and the backplane 270). The switch fabric 400 may be implemented using one or more L2 switch components arranged in any suitable fashion in the packet switch card. The switch fabric 400 communicates, via the MDB, to receive and transmit packet data in the platform 200.

The packet switch card 220 further includes a programmable controller 420. The controller 420 may take the form of any appropriate instruction-processing device such as, but not limited to, a microcontroller, a microprocessor or a network processor. The controller 420 makes routing and forwarding decisions for data packets received by the packet switch card 220.

The packet switch card 220 additionally includes a network interface 430 (e.g., an Ethernet port or optical data port) that may serve as a packet data ingress/egress point for the platform 200. Alternatively, data ingress/egress for the platform 200 is accomplished through one or more of the AGW cards that are operating as NICs, as was discussed above. In either situation, for the system 200, data packets entering the platform 200 are routed to the packet switch card 220. Once a data packet is received by the packet switch card 220, the packet is examined by the controller 420, which determines which AGW card of the platform 200 to route the packet to for processing.

When a data packet is received at the packet switch card 220, the packet switch 220 examines the data packet's headers (e.g. using the controller 420) to determine, for example, a communication session identifier for a communication session with which the clear data packet is associated. The controller 420 then determines which AGW card of the platform 200 is responsible for processing packets for the determined communication session. This determination may be made by consulting a table, such as the table shown in FIG. 5, that associates communication sessions that the platform 200 is servicing with the respective AGW cards responsible for processing those sessions. Such a table may be stored and maintained in the controller 420, for example. Alternatively, a list of the communication sessions and their associated AGW cards may be stored in a separate component in the packet switch card 220, such as in a memory device (not shown) coupled with the controller 420. It will be appreciated that other information in the data packet's headers may be used to determine which AGW card is responsible for processing the packet. After determining which AGW card is responsible for processing the data packet, the packet switch 220 forwards the data packet to that AGW card for processing (e.g., HA or PDSN processing) after which the AGW card responsible for the packet returns it to the packet switch card 220. Additional packet processing may then be performed in a similar fashion.

Once the processing of the packet is complete, the packet switch 220 receives a completed packet. Based on an examination of the headers of the completed packet, the packet switch 220 determines that processing of the packet is complete and strips out any remaining MPLS headers and/or labels that were inserted during processing. The packet switch 220 then modifies the Ethernet header appropriately and routes the completed packet to the destination address indicated in the headers (e.g., via the packet switch card 220's network interface or via an AGW card, depending on the particular embodiment).

Communication Session and Activity Load Tables

FIG. 5 illustrates a table 500 that may be maintained in the packet switch card 220 of the platform 200. The table 500 associates calls being processed by the platform 200 with the corresponding AGW cards that are responsible for processing those calls. The table 500 includes two columns 510 and 520. The column 510 contains the communication session identifiers for the calls that are being processed by the platform 200 and the column 520 includes an indication of the particular AGW card that is responsible for each session. As shown in FIG. 5, the communication session identifiers are indicated as being the IP address of a calling mobile station. For example, in row 530, a communication session for a mobile station with an IP address IP1 is listed. The communication session for IP1 is indicated as being processed by the AGW card 240. In row 540, it is shown that a call for a mobile station with an IP address IP2 is being process by the AGW card 245, while row 550 indicates that a call for a mobile station with an IP address IP3 is being processed by AGW card 250. Likewise, in rows 560, 570 and 580, it is shown that calls from IP addresses IP4, IP5 and IP6 are also being processed by the AGW card 240. Therefore, the AGW card 240 is processing four calls, while AGW cards 245 and 250 are only processing one call each. As was previously discussed, the packet switch card 220 may periodically communicate the table 500 to each of the AGW cards for use in load balancing.

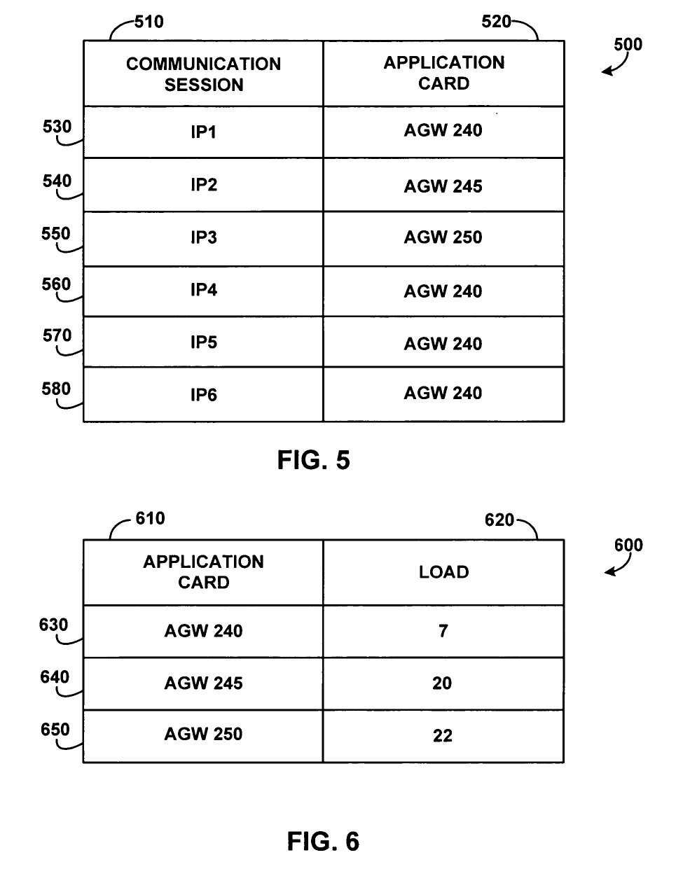

FIG. 6 illustrates a table 600 that associates respective activity loads (listed in column 620) with the AGW cards 240, 245 and 250 (listed in column 610). As was discussed above, the activity load of a particular AGW card may be determined in any number of ways. Further, the activity load may be indicated by a value within a predetermined range of numbers. For example, activity loads could be represented by values between ‘1’ and ‘100’, with ‘1’ representing little or no activity and ‘100’ representing a very high level of activity. As with the table 500 of FIG. 5, the table 600 could be maintained in the packet switch card 220 of the platform 200 and periodically communicated to the AGW cards for use in load balancing.

The activity loads in the table 600 could be determined by the individual AGW cards and then communicated to the packet switch card 220 for inclusion in the table 600. For example, for the AGW card 240 could determine its activity load by measuring the utilization of its controller 310. Alternatively, the AGW card 240 could determine its activity load by measuring its memory utilization. Each AGW may determine its activity load independently or in combination with the packet switch card 220. Alternatively, the packet switch card 220 could determine the activity loads for each of the AGW cards, such as based on the amount of data traffic routed between the individual AGW cards and the packet switch 220.

As shown in row 630 of FIG. 6, the activity load for the AGW card 240 is ‘7’ (in a range of ‘1’-‘100’, which indicates a low level of activity. This low level of activity in the AGW card 240 may indicate that most, if not all, of the calls listed in table 500 as being processed by the AGW card 240 are dormant (not actively communicating data). In comparison, rows 640 and 650 list the respective activity levels for the AGW cards 245 and 250 as ‘20’ and ‘22.’ Thus, while the AGW cards 245 and 250 only are processing a single call each, the activity loads are much higher than that of the AGW card 240, indicating that each of those calls is active. In such a situation, a new call setup up request that comes in may be assigned to the AGW card 240 for processing based on its lower activity load than the AGW cards 245 and 250. If the dormant calls being processed by the AGW card 240 then become active (start actively communicating data), the activity load of the AGW card 240 may become substantially higher than the load of the AGW cards 245 and 250. In this situation, load balancing of the calls already setup and being processed by the platform 200 is desirable.

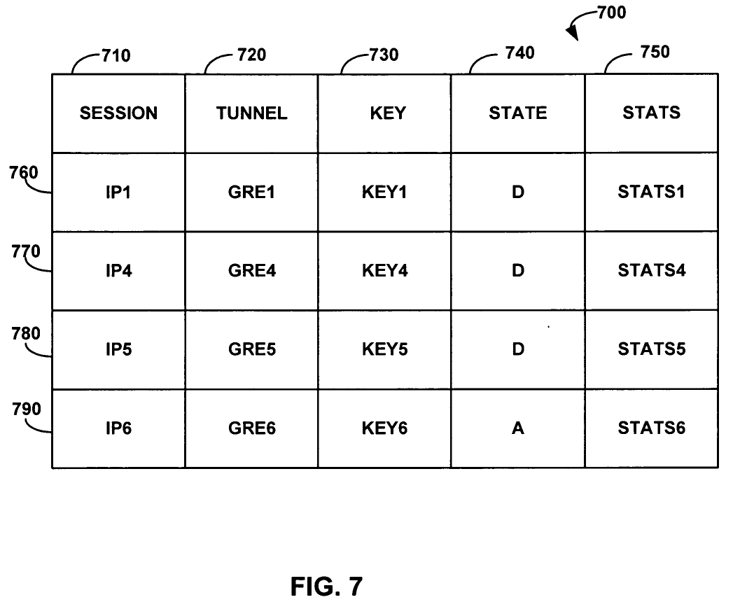

FIG. 7 illustrates a table 700 that contains the call contexts for each of the calls being processed by the AGW card 240, as were indicated in the table 500 of FIG. 5. The table 700 includes a column 710 that lists the session identifiers, or the IP addresses for each call. The table 700 also includes columns 720 and 730 that include tunnel information for each call. The column 720 includes tunnel identifiers, such as for GRE tunnels and column 730 includes the associated key (or keys) for the respective tunnels. The table 700 further includes a column 740 that includes the state of each call, such as dormant or active. The table 700 still further includes a column 750 that includes statistics for each call. For example, the statistics may include the data transfer rate of each call (e.g., bits/second) and/or the number of active/dormant transitions per second, among any number of other statistics. It will be appreciated that removal of columns, addition of columns or expansion of any of the illustrated columns into multiple columns is possible. As is shown in row 760, the call associated with the IP address IP1 is being implemented in a GRE tunnel with a tunnel identifier of GRE1 and an associated key KEY1. The state of the call is dormant and the call has call statistics STAT1. Such call contexts are described in further detail in the CDMA2000 specifications. Rows 770, 780 and 790 likewise indicate the call contexts for the other calls being processed by the AGW card 240 in this example as indicated in FIG. 5.

Method for Load Balancing Call Processing

FIG. 8 illustrates a method 800 for load balancing call processing. The method 800 may be implemented in the platform 200 and will be discussed with further reference to FIGS. 2-7. The method 800 may be used to load balance call processing in connection with providing any number of data network services, such as PDSN services or HA services.

The method 800, at block 810, includes maintaining a first table (such as the table 500 of FIG. 5) that associates a plurality of valid communication sessions being processed by a network platform (such as the platform illustrated in FIGS. 2A and 2B) with respective application processing cards (such as the AGW card 240 of FIG. 3) of a plurality of application processing cards included in the network platform. The first table 500 indicates which AGW card of the plurality is responsible for each valid communication session being processed by the network platform.

At block 820, the method 800 includes maintaining a second table (such as the table 600 of FIG. 6) that associates respective activity loads with the plurality of application processing cards. The second table is maintained by periodically updating the respective activity loads of the plurality of application processing cards, as was described above. As was also discussed above, the activity load may be represented by a measure of processor utilization, a measure of memory utilization, and/or a measure of data traffic rate, among numerous other possible parameters.

In one embodiment, the first table and the second table are maintained in a packet switch card (such as the packet switch card 220 of FIG. 4) that is operationally coupled with the plurality of application processing cards in the network platform. In this embodiment, the first and second tables are further maintained in the network platform by periodically communicating the first and second tables to the plurality of application processing cards. In other embodiments, the tables could be maintained in separate entities in the network platform or maintained together in an entity other than the packet switch, as two possible alternatives.

The method 800 then includes monitoring the respective activity loads of the plurality of application processing cards at block 830. Such monitoring may be accomplished using appropriate logic (e.g. software) included in the packet switch card 220 and/or the access gateway card 240. This logic, when executed, would determine data traffic rates, memory utilization, processor utilization and/or any other parameters that are used to measure the activity loads of the AGW cards in the network platform.

This logic (software), at block 840, determines that the activity load of a given application processing card of the plurality exceeds a predetermined limit. For instance, it may be determine that the predetermined activity load limit (threshold) as been exceed by a particular application processing card for longer than a specified period of time (e.g., 50 ms). This determination could be made in any number of ways. For example, the logic may determine that the processor and/or memory utilization of the given application processing card exceed(s) a predetermined threshold for the specified time period. Alternatively, the logic could determine that the data traffic rate between the packet switch card and the given application processing card exceeds a predetermined threshold regardless of the duration of time for which the threshold is exceeded. Of course, other alternatives for making this determination exist. For example, an examination of the first table could indicate that the number of sessions assigned to the given application processing card exceeds a predetermined threshold.

At block 850, the method 800 includes identifying a valid communication session (or sessions) being processed by the given application processing card which is (are) to be moved to another application processing card. Also at block 850, the other application processing card of the plurality to which the identified communication session(s) will be moved is determined.

Identifying the communication session(s) to be moved and the application processing card to which they will be moved is done based on the first table and/or the second table. For example, determining the other application processing card to which to move the identified communication session at block 850 may be accomplished by determining a least loaded application processing card from the second table. This determination, for this embodiment, is made by the application card for which the activity load has exceeded the predetermined activity load threshold (limit). Alternatively, determining the other application processing card to which to move the identified communication session may be accomplished using the first table, such as by determining the application processing card of the platform associated with the fewest number of valid communication sessions.

At block 860, the identified communication session is moved to the application processing card that was determined as the recipient of the session at block 850. The communication session is moved from one application processing card to the other by communicating a communication session context for the identified communication session (such as illustrated in the table 700 of FIG. 7) from the sending application processing card to the receiving application processing card (e.g., via the packet switch card) and then deleting the communication session context from the sending application processing card. The communication session context may not be deleted from the sending application processing card until the communication session is up and running on the receiving card. This approach temporarily preserves the call context on the sending application processing card in the event another transfer is required (e.g., the receiving card fails or is unable to initiate the communication session for any number of reasons).

After the moved communication session is up and running on the receiving application processing card (and the call context is deleted from the sending application processing card), the first table (e.g., the table 500) is updated to indicate that the identified communication session has been moved to another application processing card at block 870. This update may be accomplished by the application processing cards communicating their current valid sessions to the packet switch card and the packet switch card making appropriate updates to the first table. At block 880, the second table (e.g., the table 600) is updated with the new respective activity loads of the plurality of application processing cards. This update of the second table may be accomplished using periodic activity load updates that are sent from the plurality of application processing cards to the packet switch card, as was previously described. Additional load balancing may then be performed based on these new activity loads in the manner just described or in any other appropriate fashion.

### CONCLUSION

Various arrangements and embodiments have been described herein. It will be appreciated, however, that those skilled in the art will understand that changes and modifications may be made to these arrangements and embodiments without departing from the true scope and spirit of the present invention, which is defined by the following claims.

What is claimed is:

1. A method for load balancing communication session processing in a data network platform, the method comprising:
maintaining a first table associating a plurality of valid communication sessions being processed by the platform with respective application processing cards of a plurality of application processing cards included in the network platform;
maintaining a second table associating respective activity loads with the plurality of application processing cards;
monitoring the respective activity loads of the plurality of application processing cards;
determining that the activity load of a given application processing card exceeds a predetermined limit;
identifying a valid communication session being processed by the given application processing card to be moved and determining another application processing card of the plurality to which the identified session will be moved based on at least one of the first table and the second table; and
moving the identified communication session to the other application processing card.

2. The method of claim 1, wherein identifying the communication session to be moved further comprises determining that the activity load of the given application processing card exceeds the predetermined limit for a predetermined amount of time.

3. The method of claim 1, further comprising updating the first table to indicate that the identified communication session has been moved to the other application processing card.

4. The method of claim 1, further comprising updating the second table with updated respective activity loads of the plurality of application processing cards after moving the identified communication session.

5. The method of claim 1, wherein communication session processing comprises providing packet data serving node services.

6. The method of claim 1, wherein communication session processing comprises providing home agent services.

7. The method of claim 1, wherein maintaining the second table comprises periodically updating the respective activity loads of the plurality of application processing cards.

8. The method of claim 1, wherein the respective activity loads each represents a measure of processor utilization.

9. The method of claim 1, wherein the respective activity loads each represents a measure of memory utilization.

10. The method of claim 1, wherein the respective activity loads each represents a measure of data traffic.

11. The method of claim 1, wherein maintaining the first table and the second table comprises maintaining the first table and the second table in a packet switch card operationally coupled with the plurality of application processing cards.

12. The method claim 11, wherein maintaining the first table and the second table further comprises periodically communicating the first and second tables to the plurality of application processing cards.

13. The method of claim 12, wherein determining the other application processing card to which to move the identified communication session comprises determining, with the given application processing card, a least loaded application processing card from the second table communicated from the packet switch card.

14. The method of claim 12, wherein determining the other application processing card to which to move the identified communication session comprises determining, with the given application processing card, from the first table communicated from the packet switch card, an application processing card associated with the fewest number of valid communication sessions.

15. The method of claim 1, wherein moving the identified communication session comprises:
communicating a communication session context for the identified communication session from the given application processing card to the other application processing card; and
deleting the communication session context from the given application card.

16. The method of claim 15, wherein communicating the communication session context from the given application processing card to the other application processing card comprises:
communicating the communication session context from the given application card to a packet switch card operationally coupled with the plurality of application processing cards; and
communicating the communication session context from the packet switch card to the other application processing card.

17. A method for load balancing communication session processing in a data network platform, the method comprising:
maintaining a first table associating a plurality of valid communication sessions being processed by the platform with respective application processing cards of a plurality of application processing cards;
maintaining a second table associating respective activity loads with the plurality of application processing cards;
monitoring the respective activity loads of the plurality of application processing cards;
determining that the activity load of a given application processing card exceeds a predetermined limit for a predetermined period of time;
identifying a valid communication session being processed by the given application processing card to be moved to another application processing card of the plurality based on at least one of the first table and the second table;
moving the identified communication session to the other application processing card;
updating the first table to indicate that the identified communication session has been moved to the other application processing card; and
updating the second table with updated respective activity loads of the plurality of application processing cards after moving the identified communication session.

18. A network platform for processing data packets comprising:
a plurality of application processing cards;
a packet switch card operationally coupled with the plurality of application processing cards; and
a backplane for communicating data packets between the packet switch and the plurality of application processing cards,
wherein the packet switch card and the plurality of application processing cards include machine executable instructions that, when executed, collectively provide for:
maintaining a first table associating a plurality of valid communication sessions being processed by the platform with respective application processing cards of the plurality of application processing cards;
maintaining a second table associating respective activity loads with the plurality of application processing cards;
monitoring the respective activity loads of the plurality of application processing cards;
determining that the activity load of a given application processing card exceeds a predetermined limit;
identifying a valid communication session being processed by the given application processing card to be moved to another application processing card of the plurality based on at least one of the first table and the second table; and
moving the identified communication session to the other application processing card.

19. The platform of claim 18, wherein maintaining the second table comprises periodically updating the respective activity loads of the plurality of application processing cards.

20. The platform of claim 18, wherein the instructions, when executed, further provide for updating the first table to indicate that the identified communication session has been moved to the other application processing card.

21. The platform of claim 18, wherein moving the identified communication session comprises:
communicating a communication session context of the identified communication session from the given application card to the packet switch card; and
communicating the communication session context from the packet switch card to the other application processing card; and
deleting the communication session context from the given application card.

22. The platform of claim 18, wherein moving the identified communication session comprises:
communicating a communication session context for the identified communication session from the given application processing card to the other application processing card; and
deleting the communication session context from the given application card.
